(19) United States
(12) Patent Application Publication
(10) Pub. No.: US 2008/0040613 A1
(43) Pub. Date: Feb. 14, 2008

(54) APPARATUS, SYSTEM, AND METHOD FOR SECURE PASSWORD RESET

(76) Inventor: David Carroll Challener, Raleigh, NC (US)

Correspondence Address: Kunzler & McKenzie, 8 EAST BROADWAY, SUITE 600, SALT LAKE CITY, UT, 84111, US

(21) Appl. No.: 11/464,416

(22) Filed: Aug. 14, 2006

(51) Int. Cl. H04L 9/00

(52) U.S. Cl. 713/185

(57) ABSTRACT

An apparatus, system, and method are disclosed for secure password reset. In one embodiment, an authentication module authenticates a user. An authorization key module retrieves an authorization key from a backup key blob using a backup password. In a certain embodiment, the authorization key module retrieves the authorization key in response to receiving the backup password. A user password module receives a user password. An active blob creation module creates an active key blob comprising the authorization key and the user password, allowing a user to retrieve the authorization key and access a secure asset by providing the user password.

### BACKGROUND OF THE INVENTION

1. Field of the Invention

This invention relates to secure passwords and more particularly relates to securely resetting passwords.

2. Description of the Related Art

Data processing devices often store critical data and/or have access to critical data and functions such as confidential personal data, financial transaction systems, and the like. Because data processing devices may fall into the hands of and/or be accessible by unauthorized personnel, data processing devices are typically password protected. A password is required to access the data processing device, and/or to access certain critical functions and data of the data processing device.

A user may establish a password that is easily remembered. Alternatively, the user may be assigned a password. Many service organizations such as corporations, governments, and universities, and even governmental regulations, require that the user regularly change a password for a data processing device to further secure the data processing device. Changing a password may impede hackers from discovering a password, and make it less likely that the user will select a given password that is used for a plurality of other, less critical accounts.

Unfortunately, each time a password is set and/or changed, there is a possibility that the user will forget the password. When the user forgets the password, the user is unable to access the data processing device and/or the protected data and functions of the data processing device. As a result, some users have resorted to recording their new passwords on notes, which significantly reduces the protection afforded by the passwords.

If the user forgets the password, the service organization may be prohibited by policy and/or by law from recovering the password. Therefore, the service organization must reset the password for the user to access the data processing device. However, the security afforded by the password is diminished if the password is not securely reset.

From the foregoing discussion, it should be apparent that a need exists for an apparatus, system, and method that securely resets a password. Beneficially, such an apparatus, system, and method would allow a service organization to securely reset the password for a user.

### SUMMARY OF THE INVENTION

The present invention has been developed in response to the present state of the art, and in particular, in response to the problems and needs in the art that have not yet been fully solved by currently available password resetting methods. Accordingly, the present invention has been developed to provide an apparatus, system, and method for securely resetting a password that overcome many or all of the above-discussed shortcomings in the art.

The apparatus to securely reset a password is provided with a plurality of modules configured to functionally execute the steps of retrieving an authorization key, receiving a user password, and creating an active key blob. These modules in the described embodiments include an authorization key module, a user password module, and an active blob creation module. In addition, the apparatus may include an authentication module and an access module.

In one embodiment, the authentication module authenticates a user. The authentication module may authenticate the user as directed by an administrator. In a certain embodiment, the authentication module may provide identity authenticators to the administrator. Alternatively, the server may provide the backup password in response to receiving an identity authenticator from the user. A service organization may control the authentication module.

The authorization key module retrieves an authorization key from a backup key blob using a backup password. In one embodiment, the authorization key module is embodied in a data processing device. The authentication module may provide the backup password in response to authenticating the user. The backup key blob may be stored on the data processing device. In addition, the backup key blob may be encrypted with the backup password. In one embodiment, the backup password is an enterprise public key.

The user password module receives a user password. In one embodiment, a user inputs the password to the data processing device. The user password module may verify that the user password conforms to one or more password policies.

The active blob creation module creates an active key blob. The active key blob comprises the authorization key and the user password, effectively resetting a password for a secure asset to the user password. The authorization key may be retrieved from the active key blob using the user password to access the secure asset.

The access module may retrieve the authorization key from the active key blob using the user password. In addition, the access module may access the secure asset using the authorization key. The apparatus securely resets the password for accessing the secure asset on the data processing device.

A system of the present invention is also presented for securely resetting a password. The system may be embodied in a data processing system. In particular, the system, in one embodiment, includes a server and a data processing device.

In one embodiment, the server provides services for a service organization. In one embodiment, the server includes an authentication module. The authentication module may authenticate a user. The authentication module may provide a backup password to the data processing device. In one embodiment, the authentication module provides the backup password in response to authenticating the user.

The data processing device includes a TPM device, an authorization key module, a user password module, and an active blob creation module. The authorization key module retrieves an authorization key from a backup key blob using the backup password. The user password module receives a user password. The user password may be received from a user as input to the data processing device. Alternatively, the server may generate a random user password. The active blob creation module creates an active key blob. The active key blob comprises the authorization key and the user password. In one embodiment, the active key blob is encrypted with the user password. The authorization key may be retrieved from the active key blob using the user password for accessing the TPM device.

In one embodiment, the data processing device includes an access module. The access module may retrieve the authorization key from the active key blob and access the secure asset in response to receiving the user password. The system allows the server to reset the password for accessing the secure assets of the data processing device.

A method of the present invention is also presented for securely resetting a password. The method in the disclosed embodiments substantially includes the steps to carry out the functions presented above with respect to the operation of the described apparatus and system. In one embodiment, the method includes retrieving an authorization key, receiving a user password, and creating an active key blob. The method also may include authenticating the user.

In one embodiment, an authentication module authenticates a user. An authorization key module retrieves an authorization key from a backup key blob using a backup password. In a certain embodiment, the authorization key module retrieves the authorization key in response to receiving the backup password. A user password module receives a user password. An active blob creation module creates an active key blob comprising the authorization key and the user password, allowing the user to retrieve the authorization key by providing the user password. In one embodiment, an access module retrieves the authorization key and accesses a secure asset using the authorization key in response to receiving the user password. The method securely resets the password for accessing the secure assets to the user password received from the user.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention receives a backup password and accesses an authorization key from a backup key blob. In addition, the present invention receives a user password and creates an active key blob comprising the authorization key and the user password, resetting the password for accessing a secure asset to the user password. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data processing system in accordance with the present invention;

FIG. 2 is a schematic block diagram illustrating one embodiment of a secure password reset apparatus of the present invention;

FIG. 3 is a schematic block diagram illustrating one embodiment of key blobs of the present invention;

FIG. 4 is a schematic block diagram illustrating one embodiment of a data processing device of the present invention;

FIG. 5 is a schematic flow chart diagram illustrating one embodiment of a secure password reset method of the present invention; and

FIG. 6 is a schematic flow chart diagram illustrating one embodiment of a secure asset access method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

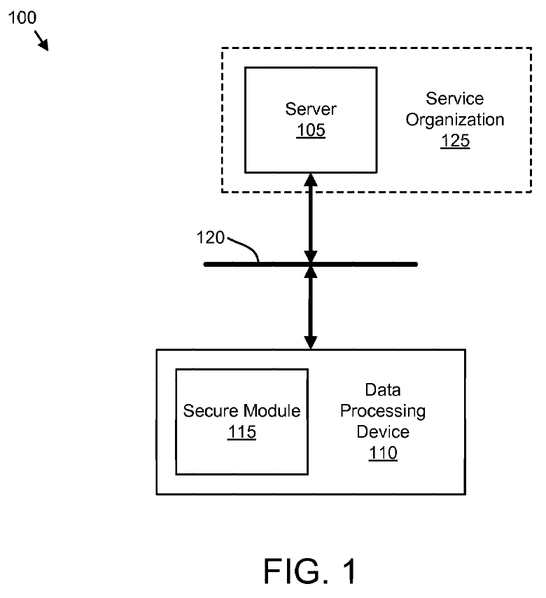

FIG. 1 is a schematic block diagram illustrating one embodiment of a data processing system 100 in accordance with the present invention. The system 100 includes a server 105 and a data processing device 110. The server 105 is controlled by a service organization 125. The data processing device 110 includes a secure asset 115.

The service organization 125 may be a corporation, a non-profit organization, a business, a service provider, a government entity, or the like. The service organization 125 may provide information technology services to the data processing device 110 for a user. The user may be an employee, a customer, or the like.

In one embodiment, the service organization 125 provides the information technology services through the server 105. Although for simplicity a single server 105 is shown providing the information technology services, any number of servers 105 may be employed.

In one embodiment, the server 105 communicates with the data processing device 110 through a communications network 120. The communications network 120 may be the Internet. Alternatively, the communications network 120 may be a wide area network. In a certain embodiment, the communications network 120 comprises communications over a telephonic connection.

The data processing device 110 may be a computer workstation, a personal digital assistant (PDA), a cellular telephone, a laptop computer, a personal entertainment device, a kiosk, or the like. The user may store critical data on the data processing device 110. Alternatively, the user may access critical data and/or functions using the data processing device 110.

The secure asset 115 may be a secure file, a secure software application, access to secure communications, secure access to an external resource, or the like. In one embodiment, the secure asset 115 manages secure functions for the data processing device 110. For example, the secure asset 115 may be configured to store one or more cryptographic keys for accessing secure data and secure functions. Cryptographic keys as used herein are referred to as keys. The secure asset 115 may also perform cryptographic operations such as random number generation, hashing, initializing the keys, and managing the keys. For example, the secure asset 115 may generate a key by generating a random number and hashing the random number to form the key.

In addition, the secure asset 115 may store and report integrity metrics. For example, the secure asset 115 may record and report the source of software and data copied to the data processing device 110, as well as whether the source is a trusted source. The secure asset 115 may also report if security for the data processing device 110 is compromised.

In one embodiment, the secure asset 115 is configured as a Trusted Platform Module (TPM) device as defined by the Trusted Computing Group. The TPM device may be configured as one or more semiconductor devices. In addition, the TPM device may include one or more software processes executing on the data processing device 110.

In one embodiment, the user must provide an authorization key or password to access the secure asset 115. Unfortunately, if the user forgets the password, the user is unable to access the secure asset 115. The service organization 125 could maintain a record of the password used to access the secure asset 115 so that the service organization 125 could provide the forgotten password to the user. Yet if the service organization 125 maintained a record of the password, someone could obtain the password from the service organization 125 and access the secure asset 115 without the permission of the user. As a result, allowing the service organization 125 to possess the password may be against a service organization policy and in some jurisdictions may be prohibited.

In order to support the user in accessing the secure asset 115 when a password is forgotten, the service organization 125 may reset the password for the secure asset 115. Resetting the password allows the user to establish, and hopefully remember, a new password for accessing the secure asset 115. Unfortunately, resetting a password may comprise the security of secure asset 1155. The embodiment of the present invention supports securely resetting the password for the secure asset 115 as will be described hereafter.

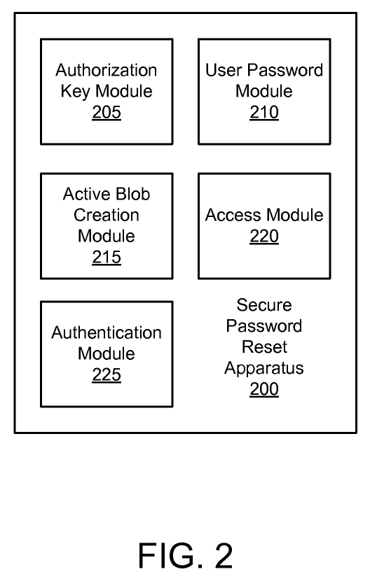

FIG. 2 is a schematic block diagram illustrating one embodiment of a secure password reset apparatus 200 of the present invention. The apparatus 200 securely resets the password for the secure asset 115 of FIG. 1. The description of the apparatus 200 refers to elements of FIG. 1, like numbers referring to like elements. The apparatus 200 includes a key authorization module 205, a user password module 210, an active blob creation module 215, an access module 220, and an authentication module 225.

In one embodiment, the authentication module 225 authenticates a user. The server 105 may comprise the authentication module 225. The authentication module 225 may authenticate the user as directed by an administrator of the service organization 125. For example, a user may request that the administrator reset the password for the secure asset 115. The administrator may verify the identity of the user in response to the user request and direct the authentication module 225 to authenticate the user.

In a certain embodiment, the authentication module 225 may provide identity authenticators to the administrator to aid the administrator in verifying the user's identity. For example, the authentication module 225 may provide the administrator with identity authenticators comprising the address and date of birth of the user. The administrator may request that the user also provide the identity authenticator information, and check the identity authenticators provided by the user with the identity authenticators provided by the authentication module 225. The administrator may direct the authentication module 225 to authenticate identity of the user if the identity authenticators provided by the user match those provided by the authentication module 225.

In an alternate embodiment, the user may communicate a request for a password reset through the communications network 120 to the authentication module 225 executing on the server 105. The request may include one or more identity authenticators. For example, the user may access a web page for resetting the password. The web page may require the user to enter identity authenticators comprising an employee number, an organizational number, and a hire date. The web page may generate an XML file containing the identity authenticators and communicate the XML file to the authentication module 225 on the server 105. The authentication module 225 may verify the received identity authenticators with stored identity authenticators and authenticate the user.

The authorization key module 205 retrieves an authorization key from a backup key blob using a backup password as will be described hereafter. In one embodiment, the authorization key module 205 is embodied in the data processing device 110. The authorization key is required to access the secure asset 115.

The user password module 210 receives a user password. In one embodiment, a user inputs the password to the data processing device 110 as will be described hereafter. The active blob creation module 215 creates an active key blob as will be described hereafter. Creating the active key blob effectively resets the password for the secure asset 115 to the user password.

In one embodiment, the active blob creation module 215 creates an initial active key blob. The initial active key blob may comprise the authorization key and a random password. In one embodiment, the initial active key blob is a copy of the backup key blob.

In one embodiment, the access module 220 retrieves the authorization key from the active key blob using the user password. In addition, the access module 220 may access the secure asset 115 using the authorization key. The apparatus 200 securely resets the password for accessing the secure asset 115 on the data processing device 110.

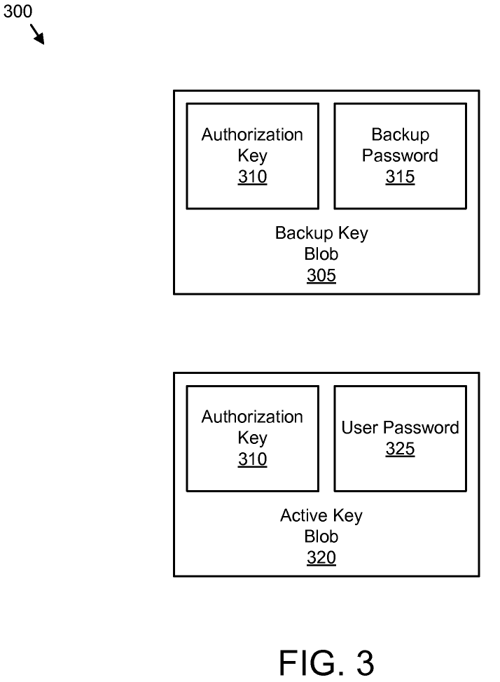

FIG. 3 is a schematic block diagram illustrating one embodiment of key blobs 300 of the present invention. The key blobs 300 include a backup key blob 305 and an active key blob 320. The description of the key blobs 300 refers to elements of FIGS. 1-2, like numbers referring to like elements.

The backup key blob 305 comprises an authorization key 310 and a backup password 315. The authorization key is required to access the secure asset 115. For example, the secure asset 115 may only be accessed after the authorization key 310 is communicated to the secure asset 115.

The authorization key 310 may be encrypted in the backup key blob 305 using the backup password 315. In one embodiment, the backup password 315 is an enterprise public key. The backup password 315 may be known to and/or within the service organization 125. In a certain embodiment, the service organization 125 stores the backup password 315 on the server 105. The server 105 may store the backup password 315 in a database entry along with the identity authenticators for the user. Alternatively, the server 105 may store the backup password 315 in a database entry with identity authenticators for the data processing device 110.

The backup key blob 305 may be encrypted with a Diffie-Hellman key exchange algorithm, an RSA encryption algorithm, a Digital Secure Standard algorithm, an EIGamal algorithm, an Elliptic Curve algorithm, a Paillier cryptosystem algorithm, or the like. In one embodiment, the data processing device 110 knows the encryption algorithm used to encrypt the backup key blob 305.

In one embodiment, the service organization 125 may create the backup key blob 305 when initializing the secure asset 115. For example, the server 105 may initialize the secure asset 115 with the authorization key 310 such that that thereafter the secure asset 115 may only be accessed using the authorization key 310. The server 105 may further create the backup key blob 305 with the backup key blob 305 comprising the authorization key 310 encrypted with the backup password 315 and store the backup key blob 305 on the data processing device 110. The encryption of the backup key blob 305 with the backup password 315 protects the backup key blob 305 and the authorization key 310 as the backup key blob 305 is communicated to the data processing device 110.

The active key blob 320 comprises the authorization key 310 and a user password 325. In one embodiment, the active key blob 320 is encrypted with the user password 325. The authorization key 310 may be retrieved from the active key blob 320 using the user password 325. For example, the user may input the user password 325 to the data processing device 110. The access module 220 may execute on the data processing device 110 and receive the user password 325. In one embodiment, the access module 220 retrieves the authorization key 310 by decrypting the active key blob 320 using the user password 325. The access module 320 may further access the secure asset 115 using the authorization key 310.

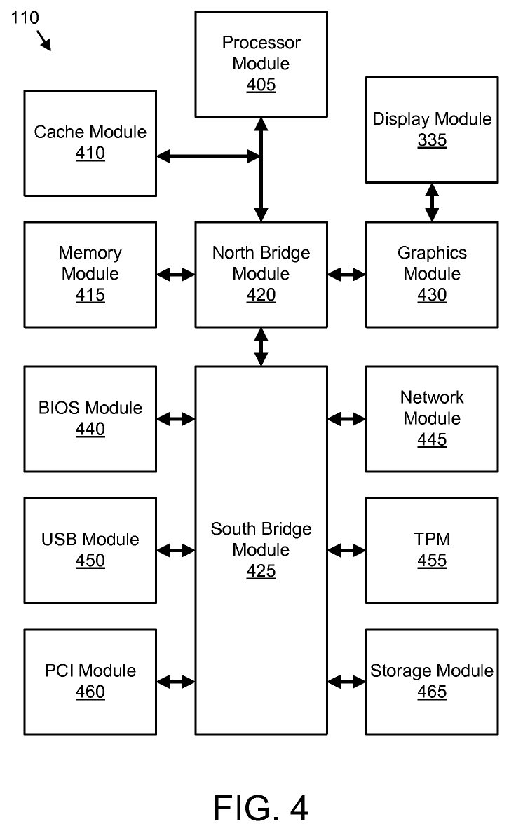

FIG. 4 is a schematic block diagram illustrating one embodiment of a data processing device 110 of the present invention. As depicted, the data processing device 110 is configured as computer that includes a processor module 405, a cache module 410, a memory module 415, a north bridge module 320, a south bridge module 425, a graphics module 430, a display module 435, a basic input/output system (BIOS) module 440, a network module 345, a universal serial bus (USB) module 450, a TPM 455, a peripheral component interconnect (PCI) module 460, and a storage module 465. Alternatively, the data processing device 110 may be configured as a cellular phone, a PDA, a personal entertainment device, a kiosk, or the like.

The description of the data processing device 110 refers to elements of FIGS. 1-3. In one embodiment, the TPM 455 is the secure asset 115 of FIG. 1. In the depicted embodiment, the present invention securely resets the user password 325 for accessing the TPM 455.

The processor module 405, cache module 410, memory module 415, north bridge module 420, south bridge module 425, graphics module 430, display module 435, BIOS module 440, network module 445, USB module 450, TPM 455, PCI module 460, and storage module 465, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory module 415 stores software instructions and data. The processor module 405 executes the software instructions and manipulates the data as is well know to those skilled in the art. In one embodiment, the memory module 415 stores and the processor module 405 executes one or more software processes comprising the key authorization module 205, user password module 210, active blob creation module 215, and access module 220.

In one embodiment, the backup key blob 305 and the active key blob 320 are stored in the memory module 415. Alternatively, the backup key blob 305 and the active key blob 320 may be stored in a storage device such as a hard disk drive of the storage module 465. Software processes executing on the processor module 405 may access the backup key blob 305 and the active key blob 320 from the storage module 465 through the north bridge module 420 and south bridge module 425.

The data processing device 110 may communicate with the server 105 through the network module 445. The network module 445 may be configured as an Ethernet interface, a token ring interface, or the like.

In one embodiment, the TPM 455 embodies the access module 220, in whole or in part. For example, the access module 220 of the TPM 455 may receive a password, access the active key blob 320 stored in the memory module 415, decrypt the active key blob 320, and verify that the retrieved authorization key 310 is the correct authorization key 310.

In a certain embodiment, the server 105 is also configured as a data processing device 110. The memory module 415 of the server 105 may store and the processor module 405 of the server 105 may execute the authentication module 225.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

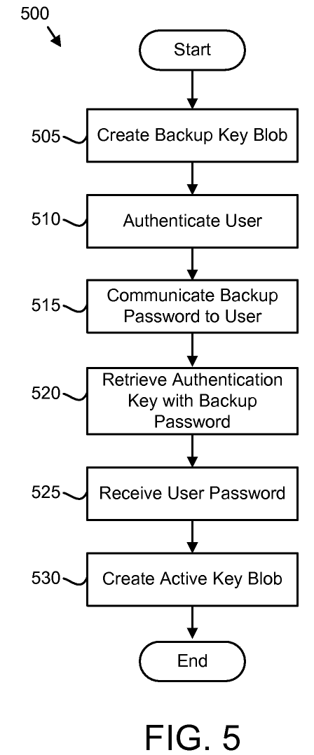

FIG. 5 is a schematic flow chart diagram illustrating one embodiment of a secure password reset method of the present invention. The method 500 substantially includes the steps to carry out the functions presented above with respect to the operation of the described apparatus 200, 300, 110 and system 100 of FIGS. 1-4. The description of the method 500 refers to elements of FIGS. 1-4, like numbers referring to like elements.

The method 500 begins and in one embodiment, the server 105 of the service organization 125 creates 505 the backup key blob 305. The server 105 may create 505 the backup key blob by generating the authorization key 310 from a random number. In one embodiment, the authorization key 310 is based on a hashed random number. The server 05 may further encrypt the authorization key 310 with the backup password 315. In a certain embodiment, the server 105 stores the backup key blob 305 to the data processing device 110.

Because the backup key blob 305 is encrypted, the backup key blob 305 may be securely communicated and stored to the data processing device 110 over the communications network 120, even if the communications network 120 is not secure. For example, if the communications network 120 comprises the Internet, the server 105 may securely communicate the backup key blob 305 over the Internet to the data processing device 110.

In one embodiment, the authentication module 225 authenticates 510 the user. In one embodiment, the authentication module 225 authenticates 510 the user by receiving a one-time access code from the user. The one-time access code may be generated by an authenticator such as an RSA SecruID Token produced by RSA Security, Inc. of Bedford, Mass. The authentication module 225 may compare the one-time access code with a code stored on the server 105 to authenticate 510 the user.

In an alternate embodiment, the authentication module 225 may authenticate 510 the user by receiving biometric data from a biometric identification device. The biometric identification device may scan the user's fingerprint, scan the user's retina, record a voiceprint of the user, or the like to acquire biometric data. The biometric identification device may communicate the biometric data to the authentication module 225. The authentication module 225 may compare the received biometric data to known biometric data for the user stored on the server 105 to authenticate 510 the user.

The authentication module 225 may also authenticate 510 the user as directed by the administrator and/or in response to receiving identity authenticators as discussed previously. Authenticating 510 the user assures that user password 325 is only reset for the authorized user of the data processing device 110.

In one embodiment, the authentication module 225 communicates 515 the backup password 315 to the data processing device 110. The communicated backup password 315 may be encrypted with a key known to the user such as an enterprise public key.

The authorization key module 205 retrieves 520 the authorization key 310 from the backup key blob 305 using the backup password 315. The authorization key module 205 may decrypt the backup key blob 305 using the backup password 315 to retrieve the backup password 315. In one embodiment, the authorization key module 205 retrieves 520 the authorization key 310 in response to receiving the backup password 315. For example, the authentication module 225 may communicate 515 the backup password 315 as part of an XML script. The XML script may initiate the execution of the authorization key module 205 and direct the authorization key module 205 to recover the backup password 315 and use the backup password 315 to retrieve 520 the authorization key 310. In an alternate embodiment, the authorization key module 205 retrieves 520 the authorization key in response to the authentication module 225 authenticating 510 the user.

The user password module 210 receives 525 the user password 325. In one embodiment, the user password module 210 prompts the user to input the user password 325. The user password module 210 may also provide the user with one or more rules or policies for a valid user password 325. For example, the user password module 210 may notify the user that the user password 325 must be a specified number of alphanumeric characters in length. The user password module 210 may receive 525 the user password as input by the user and verify that the user password 325 conforms to the user password policies. The user password module 210 may further communicate the user password to the active blob creation module 215.

The active blob creation module 215 creates 530 the active key blob 320. In one embodiment, the active blob creation module 215 encrypts the authorization key 310 with the user password 325 to create 530 the active key blob 320. The active blob creation module 215 may store the active key blob 320 on the data processing device 110 such as in the memory module 415 and/or storage module 465. The secure asset 115 may be accessed with the active key blob 320 using the user password 325 as will be described hereafter. Thus the user password 325 for the secure asset 115 is securely reset, although the service organization 125 does not possess the user password 325.

In one embodiment, the active blob creation module 215 deletes the backup key blob 305 and creates and saves a new backup key blob encrypted with a new backup password. In one embodiment, the active blob creation module 215 may receive the new backup password from the service organization 125 through the server 105. Alternatively, the active blob creation module 215 may select a known enterprise public key according to a policy as the new backup password for the new backup key blob. The method 500 securely resets the password for the secure asset 115 to the user password 325.

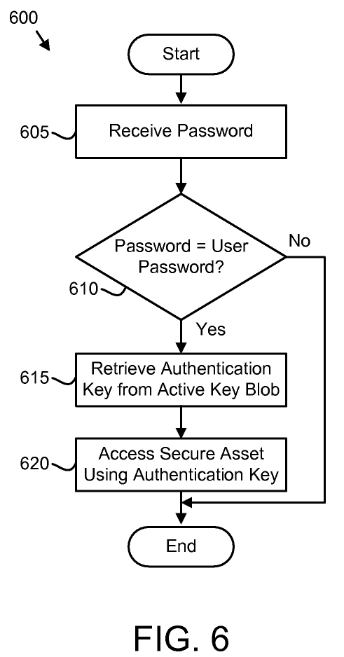

FIG. 6 is a schematic flow chart diagram illustrating one embodiment of a secure asset access method 600 of the present invention. The method 600 substantially includes the steps to carry out the functions presented above with respect to the operation of the described apparatus 200, 300, 110, system 100, and method 500 of FIGS. 1-5. The description of the method 600 refers to elements of FIGS. 1-5, like numbers referring to like elements.

The method 600 begins and in one embodiment, the access module 220 receives 605 a password that is input by the user. In one embodiment, the password is input to the data processing device 110. In an alternate embodiment, the password is communicated to the data processing device 110 from a separate device. For example, the password may be input to a portable security device configured to store passwords and keys. The portable security device may communicate the password to the data processing device 110.

The access module 220 determines 610 if the password is equivalent to the user password 325. In one embodiment, the access module 220 determines 610 the password is equivalent to the user password 325 if the password successfully decrypts the active key blob 320 and retrieves the authorization key 310. In a certain embodiment, the access module 220 determines the password is equivalent to the user password 325 if the authorization key 310 decrypted from the active key blob 320 accesses the secure asset 115. If the access module 220 determines 610 the password is not equivalent to the user password 325, the method 600 terminates.

If the access module 220 determines 610 the password is equivalent to the user password 325, the access module 220 may retrieve 615 the authorization key 310 from the active key blob 320. The access module 220 may retrieve 615 the authorization key by decrypting the active key blob 320 with the user password 325.

In one embodiment, the access module 220 accesses 620 the secure asset 115 using the retrieved authorization key 310. The access module 220 may communicate the authorization key 310 to the secure asset 115 to access the secure asset 115. Alternatively, the access module 220 be embodied within the secure asset 115 and may compare the authorization key 310 with a key stored with the secure asset 115, allowing access to the secure asset 115 if the authorization key 310 and the stored key match. Accessing 620 the secure asset 115 may allow the user to access secure keys and/or secure functions of the secure asset 115.

The embodiment of the present invention receives a backup password 315 and accesses an authorization key 310 from a backup key blob 305. In addition, the present invention receives 525 a user password 325 and creates an active key blob 320 comprising the authorization key 310 and the user password 325, resetting the password for accessing a secure asset 115 to the user password 325.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for secure password reset, the apparatus comprising:
an authorization key module configured to retrieve an authorization key from a backup key blob using a backup password;
a user password module configured to receive a user password; and
an active blob creation module configured to create an active key blob comprising the authorization key and the user password, wherein the authorization key is retrievable from the active key blob using the user password to access a secure asset.

2. The apparatus of claim 1, wherein the secure asset is configured as a Trusted Platform Module (TPM) device.

3. The apparatus of claim 1, wherein the backup password is known to a service organization.

4. The apparatus of claim 1, wherein the backup password is configured as an enterprise public key.

5. The apparatus of claim 1, further comprising an access module configured to retrieve the authorization key from the active key blob and access the secure asset in response to receiving the user password.

6. The apparatus of claim 1, wherein the active blob creation module is further configured to create an initial active key blob comprising the authorization key and a random password.

7. A computer program product comprising a computer useable medium having a computer readable program, wherein the computer readable program when executed on a computer causes the computer to:
retrieve an authorization key from a backup key blob using a backup password;
receive a user password; and
create an active key blob comprising the authorization key and the user password, wherein the authorization key is retrievable from the active key blob using the user password to access a secure asset.

8. The computer program product of claim 7, wherein the secure asset is a TPM device.

9. The computer program product of claim 7, wherein the backup password is known to a service organization.

10. The computer program product of claim 7, wherein backup password is an enterprise public key.

11. The computer program product of claim 7, wherein the computer readable code is further configured to cause the computer to receive the user password from a user.

12. The computer program product of claim 7, wherein the computer readable code is further configured to cause the computer to retrieve the authorization key in response to receiving the user password.

13. The computer program product of claim 7, wherein the computer readable code is further configured to cause the computer to create an initial active key blob comprising the authorization key and a random password.

14. The computer program product of claim 7, wherein the computer readable code is further configured to cause the computer to delete the backup key blob and save a new backup key blob encrypted with a new backup password.

15. A system for secure password reset, the system comprising:
a server configured to provide a backup password from a service organization;
a data processing device comprising
a TPM device;
an authorization key module configured to retrieve an authorization key from a backup key blob using the backup password;
a user password module configured to receive a user password; and
an active blob creation module configured to create an active key blob comprising the authorization key and the user password, wherein the authorization key is retrievable from the active key blob using the user password to access the TPM device.

16. The system of claim 15, wherein the backup password is configured as an enterprise public key.

17. The system of claim 15, the data processing device further comprising an access module configured to retrieve the authorization key and access the TPM device in response to receiving the user password.

18. A method for deploying computer infrastructure, comprising integrating computer-readable code into a computing system, wherein the code in combination with the computing system is capable of performing the following:
retrieving an authorization key from a backup key blob using a backup password;
receiving a user password; and
creating an active key blob comprising the authorization key and the user password, wherein the authorization key is retrievable from the active key blob using the user password to access a secure asset.

19. The method of claim 18, wherein the method comprises accessing the secure asset using the authorization key in response to receiving the user password.

20. The method of claim 19, wherein the method further comprises authenticating the user.
